(19) United States
(12) Patent Application Publication
(10) Pub. No.: US 2024/0196946 A1
(43) Pub. Date: Jun. 20, 2024

(54) METABOLICALLY MODIFIED VANILLA BEANS AND METHODS FOR PRODUCING SAME

(71) Applicant: VANILLA TECHNOLOGIES LTD., Yesod HaMa'ala (IL)

(72) Inventor: Raz KRIZEVSKI, Ashdod (IL)

(21) Appl. No.: 18/272,258

(22) PCT Filed: Jan. 2, 2022
(86) PCT No.: PCT/IL2022/050001

§ 371 Date: Jul. 13, 2023

Related U.S. Application Data
(60) Provisional application No. 63/177,471, filed on Apr. 21, 2021.
(60) Provisional application No. 63/145,078, filed on Feb. 3, 2021.

(51) Int. Cl. A23L 27/00; A23L 27/10; A23L 33/10

(52) U.S. Cl. CPC A23L 27/88; A23L 27/10; A23L 33/10

(57) ABSTRACT

Disclosed are metabolically modified vanilla beans and methods for producing same.

### CROSS REFERENCE TO RELATED APPLICATIONS

This application is a bypass Continuation of PCT Patent Application No. PCT/IL2022/050001 having International filing date of Jan. 2, 2022, which claims the benefit of priority of U.S. Provisional Patent Application No. 63/177,471, filed Apr. 21, 2021 and U.S. Provisional Patent Application No. 63/145,078, filed Feb. 3, 2021, the contents of which are all incorporated herein by reference in their entirety.

### TECHNICAL FIELD OF INVENTION

This disclosure is generally related to vanilla beans having a modified flavor and/or aroma profile and methods for producing same, specifically, the disclosure relates to non-GMO metabolic manipulation of the flavor and/or aroma profile of vanilla beans.

### BACKGROUND

Vanilla extract is widely used as a flavor by the food and beverage industry and is used increasingly in perfumes. The U.S. annual consumption of vanilla beans, all of which are imported from foreign countries, is 1,200-1,400 tons. By FDA definition, vanillin can be labeled as natural only when it is derived from vanilla beans. Currently, natural vanilla obtained through extraction of vanilla beans as described below, costs about $200-450 per kilogram.

Today most of the market from a volume perspective is synthetic vanillin (95% by volume with 50% by ravenous) while natural vanilla beans represent a smaller portion (5% by volume with 50% by ravenous). In recent years a global go natural market trend pushes big food manufacturers to replace synthetic colors and flavors with natural ones. In vanilla today the demand for natural vanilla greatly exceeds the world ability to supply (4000 tons vs 2500 tons annually respectively). This is mostly due to the fact the area of the world capable of supporting vanilla cultivation is limited, due to its requirement for a warm, moist and tropical climate with frequent, but not excessive, rain, and moderate sunlight. Moreover, today 70-80% of natural vanilla is produced in Madagascar which is exposed to cyclones and fusarium and cause a major challenge due to supply chain instability, thus preventing the go natural market trend.

Three major species of vanilla currently are grown globally, all of which derive from a species originally found in Mesoamerica. These are V. planifolia (syn. V. fragrans), grown on Madagascar, Réunion, and other tropical areas along the Indian Ocean; V. tahitensis, grown in the South Pacific; and V. pompona, found in the West Indies, Central America, and South America. The majority of the world's vanilla is the V. planifolia species, more commonly known as Bourbon vanilla (after the former name of Réunion, Île Bourbon) or Madagascar vanilla, which is produced in Madagascar and neighboring islands in the southwestern Indian Ocean, and in Indonesia. Madagascar's and Indonesia's cultivations produce two-thirds of the world's supply of vanilla.

The production of vanilla beans is a lengthy process that is highly dependent on suitable soil and weather conditions. Beans (pod-like fruit) are produced after 4-5 years of cultivation. Flowers must be hand-pollinated, and fruit production takes about 8-10 months.

The constituents of the vanilla flavor, in particular vanillin, vanillic acid, para-hydroxybenzoic acid and para-hydroxybenzoic aldehyde, are practically absent from the mature green bean at harvest and only slowly form in the bean after picking, in a process called “curing,” traditionally done outside in the sun and lasting an additional 3-6 months. Several factors determine the specific vanilla flavor profile of a certain batch: the grown variety (genetics), environmental conditions and agro-techniques (environment), a pretreatment termed “killing” in which the beans are softened by short heating or freezing and drying, curing or drying which is traditionally done in open field conditions, and storage of the dried beans. The traditional curing process in which the environmental conditions are not controlled, typically results in low stability and repeatability of the flavor profile between different batches of Vanilla, and yield is often lost or reduced due to mold, such that most of the harvested vanilla is not converted to a premium quality product.

Thus, it is not surprising that vanilla is the second-most expensive spice after saffron. Yet, nevertheless, vanilla is widely used in both commercial and domestic baking, perfume manufacture, and aromatherapy.

Interest has focused recently on plant cell and tissue culture as an approach to control quality and yield of vanilla production and to solve some of the agronomic problems associated with growing vanilla. However, these efforts have not resulted in economically significant amounts of vanillin production.

There thus remains a need for improved methods for producing vanilla with an optimal aroma and flavor profile, in particular for methods producing such optimal profile in the intact vanilla bean, whilst avoiding genetic manipulation.

### SUMMARY

There is provided herein, according to some aspects of the disclosure, a method for manipulating a metabolic profile of vanilla beans, the method comprising adding a chemical compound to a solution comprising vanilla beans, such that the chemical compound penetrates the vanilla beans, and thereby causing a modification in the metabolic profile of the vanilla beans.

According to other aspects of the disclosure, there are provided vanilla beans having a unique, non-naturally occurring metabolic profile, giving the vanilla bean an enhanced and/or modified aroma and/or flavor.

Advantageously, the metabolic manipulation may be carried out on whole vanilla beans i.e. without cutting them or otherwise harming/altering the integrity of the beans. This is particularly beneficial since cutting the beans may result in an undesired oxidation of flavor constituents which significantly reduces shelf life.

As a further advantage, by modifying the amount, type and/or combination of the chemical compounds used, the flavor, aroma and/or color of the vanilla bean may be controlled, thereby both ensuring a desired taste, smell and look of the bean as well as the consistency thereof, between different batches of vanilla beans.

As a further advantage, the process is short and cost effective and does not require complex plant tissue cultures or bioreactors.

In addition, the vanilla beans, as well as extracts, seeds or other derivatives obtained from the beans, are natural and non-GMO, i.e., no genetic modification/manipulation of the bean is involved.

According to some embodiments, there is provided a method for manipulating a metabolic profile of vanilla beans, the method comprising adding a chemical compound to a solution comprising the vanilla beans, such that the chemical compound penetrates into the vanilla beans, thereby obtaining vanilla beans having a modified metabolic profile.

According to some embodiments, the vanilla beans are whole vanilla beans.

According to some embodiments, manipulating the metabolic profile comprises enhancing a flavor of the vanilla bean, modifying a flavor profile of the vanilla bean, changing a color of the vanilla bean or any combination thereof. According to some embodiments, manipulating the metabolic profile comprises enhancing a flavor of the vanilla bean and/or modifying a flavor profile of the vanilla bean.

According to some embodiments, the chemical compound is a flavor compound intermediate, an elicitor, a hormone, a metabolite or any combination thereof.

According to some embodiments, the compound is an elicitor.

According to some embodiments, the chemical compound is selected from p-coumaric acid, trans-cinnamic acid, ferulic acid, Leucine, isoleucine, L-phenylalanine, valine alanine, proline, pyruvic acid, glucose, fructose, sucrose, L-glutathione, methyl jasmonate, salicylic acid, chitosan, cyclodextrin, xylose, pectin, kinetin, dextran, indole butyric acid, α-ketoglutaric acid, malic acid, fumaric acid, succinic acid, maleic acid, glycine, serine, 2-furoic acid, alanine, hydroxyproline, histidine or any combination thereof.

According to some embodiments, adding the chemical compound comprises adding 0.1-500 mM of the metabolic manipulation compound. According to some embodiments, the chemical compound comprises adding 1-100 mM of the metabolic manipulation compound.

According to some embodiments, the method further includes adding a penetration agent to the solution. According to some embodiments, the penetration agent is a surfactant. According to some embodiments, the surfactant is a non-ionic surfactant. According to some embodiments, the surfactant is selected from the group of PEG 20 sorbitan monolaurate, PEG 20 sorbitan monooleate, Sorbitan monolaurate, Sorbitan monooleate, or any combination thereof. Each possibility is a separate embodiment. According to some embodiments, the penetration agent comprises adding 0.05%-1% of the penetration agent. According to some embodiments, the adding of the penetration agent comprises adding at 0.1%-5% of the penetration agent.

According to some embodiments, the vanilla beans are incubated with the chemical compound for at least 24 h.

According to some embodiments, the method is carried out after harvest and/or prior to and/or during curing.

According to some embodiments, there is provided a vanilla bean obtained according to the method disclosed herein.

According to some embodiments, there is provided a metabolically modified vanilla bean, the vanilla bean comprising at least 10% 3-hydroxy-Benzaldehyde out of total volatile fraction; or at least 3% 3-phenyl-2-Propenoic acid methyl ester out of total volatile fraction; or at least 1% 2-methyl-Butanal.

According to some embodiments, the metabolically modified vanilla bean comprises at least 15% 3-hydroxy-Benzaldehyde out of total volatile fraction.

According to some embodiments, the metabolically modified vanilla bean comprises at least 5% 3-phenyl-2-Propenoic acid methyl ester out of total volatile fraction.

According to some embodiments, the metabolically modified vanilla bean comprises at least 2% 2-methyl-Butanal out of total volatile fraction.

According to some embodiments, the metabolically modified vanilla bean comprises less than 10% acetic acid, creosol and/or acetoin.

According to some embodiments, the metabolically modified vanilla bean further comprises ethanol, ammonium acetate, isosorbide and/or 2,4-di-tert-butylphenol. Each possibility is a separate embodiment.

According to some embodiments, there is provided a metabolically modified vanilla bean comprising at least 0.05% Salicylic acid and/or p-hydroxyphenyl Phosphonic acid.

According to some embodiments, the metabolically modified vanilla bean comprises less than 5% acetic acid, creosol and/or acetoin. Each possibility is a separate embodiment.

According to some embodiments, the metabolically modified vanilla bean comprises 4-isopropylphenyl carbonic acid methyl ester, Isosorbide, and/or 2,4-di-tert-butylphenol.

According to some embodiments, there is provided a metabolically modified vanilla bean, the vanilla bean comprising at least 10% 2,3-Butanediol out of total volatile fraction.

According to some embodiments, the metabolically modified vanilla bean comprises at least 15% 2,3-Butanediol out of total volatile fraction.

According to some embodiments, the metabolically modified vanilla bean comprises less than 3% creosol and/or benzeneacetaldehyde.

According to some embodiments, the metabolically modified vanilla bean further comprises 1-Methoxy-2-propyl acetate, Propyl-cyclopentane, 2-(2-Butoxyethoxy)-ethanol, Cyclobutanecarboxylic acid octyl ester, Octanoic acid ethyl ester or any combination thereof. Each possibility is a separate embodiment.

According to some embodiments, there is provided a metabolically modified vanilla bean comprising at least 0.05% Benzenecarbothioic acid and/or 2-Hydroxy-1-phenyl-ethanone and/or Alpha-ethylidene-Benzeneacetaldehyde out of total volatile fraction; or at least 3% Phenylethyl Alcohol out of total volatile fraction; or at least 2% 3-Phenyl-2-propenoic acid methyl ester.

According to some embodiments, the metabolically modified vanilla bean comprises at least 4% Phenylethyl Alcohol out of total volatile fraction.

According to some embodiments, the metabolically modified vanilla bean comprises at least 5% 3-Phenyl-2-propenoic acid methyl ester out of total volatile fraction.

According to some embodiments, the metabolically modified vanilla bean comprises less than 1% creosol, benzeneacetaldehyde and/or acetic acid.

According to some embodiments, the metabolically modified vanilla bean further comprises 2-Hydroxy-1-phenyl-ethanone, Benzenecarbothioic acid, 3-phenyl Furan, dimethyl Silanediol, Alpha-ethylidene-Benzeneacetaldehyde or any combination thereof. Each possibility is a separate embodiment.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The invention will now be described in relation to certain examples and embodiments with reference to the following illustrative figures so that it may be more fully understood.

FIG. 1 shows a spectrophotometric quantitative analysis presented as vanillin levels percentage relative to control. Incubation of beans with the indicated compounds (blue bars) and water as control (red bar). Each bar represents the average of 8 beans.

FIG. 2 shows the proportion of beans evaluated as having a vanillic flavor (blue) vs other flavors (red) in a sensory panel analysis. Each bar represents the average of 8 beans.

FIG. 3A shows Gas Chromatography-Mass Spectrometry headspace analysis of Vanilla planifolia beans incubated with the indicated compounds. Compounds higher than 1% of the volatile fraction are presented.

FIG. 3B shows GC-MS headspace analysis of Vanilla planifolia beans incubated with salicylic acid. The analysis was repeated twice with similar results. The control is represented by blue bars while treated beans are depicted in orange bars.

FIG. 3C shows GC-MS headspace analysis of Vanilla planifolia beans incubated with chitosan. The analysis was repeated twice with similar results. The control is represented by blue bars while treated beans are depicted in orange bars.

FIG. 3D shows GC-MS headspace analysis of Vanilla planifolia beans incubated with pyruvate. The analysis was repeated twice with similar results. The control is represented by blue bars while treated beans are depicted in orange bars.

FIG. 3E shows GC-MS headspace analysis of Vanilla planifolia beans incubated with phenylalanine. The analysis was repeated twice with similar results. The control is represented by blue bars while treated beans are depicted in orange bars.

FIG. 4A shows GC-MS headspace analysis of Vanilla planifolia (killed by freezing and thawing) beans and either incubated with valine, leucine and isoleucine or left untreated (control). The analysis was repeated twice with similar results. The control is represented by blue bars while treated beans are depicted in orange bars.

FIG. 4B shows GC-MS headspace analysis of Vanilla planifolia beans killed by mechanical disruption and either incubated with valine, leucine and isoleucine or left untreated (control). The analysis was repeated twice with similar results. The control is represented by blue bars while treated beans are depicted in orange bars.

FIG. 5A shows GC-MS headspace analysis of Vanilla planifolia beans (killed by freezing and thawing) and either incubated with pyruvate and phenylalanine or left untreated (control). The analysis was repeated twice with similar results. The control is represented by blue bars while treated beans are depicted in orange bars.

FIG. 5B shows GC-MS headspace analysis of Vanilla planifolia beans killed by mechanical disruption and either incubated with pyruvate and phenylalanine or left untreated (control). The analysis was repeated twice with similar results. The control is represented by blue bars, while treated beans are depicted in orange bars.

FIG. 6 shows GC-MS headspace analysis of Vanilla planifolia beans killed by either mechanical disruption or traditional killing by heating (control). The analysis was repeated twice with similar results. The control is represented by blue bars, while treated beans are depicted in orange bars.

FIG. 7 shows the proportion of beans evaluated as having a vanillic flavor (blue) vs other flavors (red) in a sensory panel analysis. Each bar represents the average of 6 beans.

FIG. 8 shows the proportion of beans evaluated as having various flavors in a sensory panel analysis. Each bar represents the average of 6 beans.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

For convenience, certain terms used in the specification, examples, and appended claims are collected here. Unless otherwise defined, all technical and scientific terms used herein have the same meaning as commonly understood by one of ordinary skill in the art to which this invention pertains.

There is provided herein, according to some aspects of the disclosure, a method for manipulating a metabolic profile of vanilla beans, the method comprising adding a chemical compound to a solution comprising vanilla beans, such that the chemical compound penetrates the vanilla beans, and thereby cause a modification in the metabolic profile of the vanilla beans.

According to some embodiments, the method may include adding a “cocktail” of chemical compounds to the solution.

As used herein, the term “cocktail of chemical compounds” may refer to two or more, three or more or 4 our more chemical compounds. According to some embodiments, the concentration of each of the chemical compounds in the cocktail may be the same or different depending on the compound and/or the taste desired to be enhanced.

A non-limiting example of a suitable cocktail is a cocktail comprising valine, leucine and isoleucine. According to some embodiments, the concentration of each of the valine, the leucine and the isoleucine may be 15-50 mM. Another non-limiting example of a suitable cocktail is a cocktail comprising pyruvate and phenylalanine. According to some embodiments, the concentration of each of the pyruvate and phenylalanine may be 15-150 mM. Another non-limiting example of a suitable cocktail is a cocktail comprising chitosan and salicylic acid. According to some embodiments, the concentration of each of the chitosan and salicylic acid may be 0.5-50 mM.

Additionally or alternatively, the method may include killing the vanilla beans by subjecting them to mechanical disruption. According to some embodiments, the mechanical disruption comprises subjecting the beans to hammering. Additionally or alternatively, the mechanical disruption comprises subjecting the beans to vortexing. Additionally or alternatively, the mechanical disruption comprises subjecting the beans to sonication. Additionally or alternatively, the mechanical disruption comprises subjecting the beans to microwaves. Additionally or alternatively, the mechanical disruption comprises subjecting the beans to radiofrequency waves.

According to some embodiments, the mechanical disruption causes a change in the metabolic profile of the vanilla bean, as compared to killing by subjecting the vanilla beans to freezing-thawing and/or as compared to killing by heating (65° C. for 2.5 minutes).

As used herein, the term “killing” refers to an initial step, performed prior to the curing of the vanilla bean. Without being bound by any theory, the killing stops the ripening process of the vanilla bean and opens the cell walls to release enzymes and vanillin precursors.

According to other aspects of the disclosure, there are provided vanilla beans having a unique, non-naturally occurring metabolic profile, giving the vanilla bean an enhanced and/or changed aroma and/or flavor.

As used herein, the term “manipulating a metabolic profile of vanilla beans” may refer to changing the concentration of one or more flavor or aroma compounds, their precursors or their derivatives, such that a vanilla bean having an enhances flavor/aroma or a different flavor/aroma profile, as compared to the same untreated bean, is obtained. The term refers to a change in the flavor/aroma profile achieved post-harvest, i.e. after harvesting of the vanilla bean. According to some embodiments, the manipulation is carried out post-harvest and pre-curing of the beans.

As used herein, the term “chemical compound” refers to any substance composed of identical molecules consisting of atoms of two or more chemical elements. According to some embodiments, the term excludes enzymes and other proteins. According to some embodiments, the chemical compound may be a flavor pathway intermediate (e.g. p-Coumaric acid), an elicitor (e.g. salicylic acid), a general metabolite (e.g. Pyruvic acid), a hormone (e.g. Indole butyric acid) or any combination thereof. Each possibility is a separate embodiment. According to some embodiments, the chemical compound is an elicitor.

As used herein, the term “elicitor refers” to extrinsic or foreign molecules often associated with plant pests, diseases or synergistic organisms. Elicitor molecules can attach to special receptor proteins located on plant cell membranes and result in an enhanced synthesis of metabolites which reduce damage and increase resistance to pest, disease or environmental stress. Elicitors and effectors differ from hormones in that they are not produced within the organism in which they are triggering a response, and are usually not naturally occurring in the organism.

According to some embodiments, the chemical compound is L-Phenylalanine, Leucine, Isoleucine, Valine, Pyruvic acid, Salicylic acid, Chitosan, L-glutathione or any combination thereof. Each possibility is a separate embodiment.

As used herein, the terms “approximately” or “about” in reference to a number are generally taken to include numbers that fall within a range of 5% or in the range of 1% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

As used herein, the singular forms “a,” “an” and “the” include plural referents unless the context clearly dictates otherwise.

As used herein, “optional” or “optionally” means that the subsequently described event or circumstance does or does not occur, and that the description includes instances where said event or circumstance occurs and instances where it does not.

As used herein, the term “penetration” with regards to the chemical compound refers to the chemical compound passing through the cuticle layer of the vanilla bean. According to some embodiments, penetration of the chemical compound is facilitated by adding a penetration agent to the solution comprising the chemical compound. According to some embodiments, the penetration agent is a surfactant. According to some embodiments, the surfactant is a non-ionic surfactant. According to some embodiments, the surfactant is selected from the group of PEG 20 sorbitan monolaurate, PEG 20 sorbitan monooleate, Sorbitan monolaurate, Sorbitan monooleate, or any combination thereof. Additionally or alternatively, the penetration may be accomplished by mechanical scaring and/or piercing of the vanilla bean.

According to some embodiments, the vanilla beans, produced according to the herein disclosed processes, may have various flavor and/or aromatic profile depending on the amount, type and/or combination of chemical compounds used. According to some embodiments, the vanilla bean is a post-harvest manipulated vanilla bean. According to some embodiments, the vanilla bean is not genetically manipulated, i.e. no transformation or gene editing is performed on the vanilla plant from which the vanilla beans are harvested. According to some embodiments, the flavor manipulation of the vanilla bean does not involve/require breeding or other natural biological processes.

According to some embodiments, the vanilla bean may be metabolically modified. As used herein the term “metabolically modified” with regards to the flavor and/or aroma profile of the vanilla bean may, according to some embodiments, refer to vanilla beans having an enhanced/modified flavor and/or aroma profile as compared to vanilla beans from a same species, a same country of origin and/or a same batch, which were not treated with the chemical compound or compounds.

According to some embodiments, the vanilla bean may have a non-naturally occurring flavor and/or aroma profile. As used herein the term “non-naturally occurring” with regards to the flavor and/or aroma profile of the vanilla bean may, according to some embodiments, refer to vanilla beans having an enhanced/modified flavor and/or aroma profile which is not found amongst vanilla beans whether from a same or different batch or a same or different species.

According to some embodiments, the vanilla bean may have an at least 1.2 times, at least 1.5 times, or at least 2 as high concentration of vanillin, as compared to its untreated/mock treated control (same species and/or same batch). Each possibility is a separate embodiment.

According to some embodiments, the vanilla bean may have an at least 2 times, at least 1.5 times, or at least 1.2 times reduction in the concentration of vanillin, as compared to its untreated/mock treated control (same species and/or same batch). Each possibility is a separate embodiment.

According to some embodiments, the vanilla beans may include at least 20%, at least 30%, at least 40%, at least 50% percent or at least 55% vanillin out of the total volatile fraction. Each possibility is a separate embodiment. According to some embodiments, the vanilla beans include 20%-80%, 25%-75%, 25%-70%, 25%-60%, 30%-60% or 50%-70% vanillin out of the total volatile fraction. Each possibility is a separate embodiment.

According to some embodiments, vanillin may comprise at least 1%, 2%, 3%, 4% or 5% of the total weight of the dry/cured vanilla bean. Each possibility is a separate embodiment.

Advantageously, these percentages of vanillin may be obtained in vanilla beans harvested 9 months or less, 8 month or less or 7 month or less from the flowering of the vanilla plant. Each possibility is a separate embodiment. As a non-limiting example, vanillin may comprise at least 1% of the total weight of a dry vanilla bean, harvested about 7 months from the flowering of the vanilla bean. As another non-limiting example, vanillin may comprise at least 3% of the total weight of a dry vanilla bean, harvested about 9 months from the flowering of the vanilla bean.

According to some embodiments, the vanilla bean is a vanilla bean metabolically modified by treatment with chitosan.

According to some embodiments, the vanilla bean has increased levels of 3-hydroxy-Benzaldehyde and 2-methyl-Butanal providing a nutty coffee-like flavor and a decreased level of acetic acid, creosol and acetoin providing vinegar, anisic and floral flavors.

According to some embodiments, the vanilla bean may include at least 10%, at least 15% or at least 20% of 3-hydroxy-Benzaldehyde out of the total fraction of volatile compounds. Each possibility is a separate embodiment.

According to some embodiments, the vanilla bean may include at least 3%, at least 4% at least 5%, at least 6% or at least 7% of 3-phenyl-2-Propenoic acid methyl ester out of the total fraction of volatile compounds. Each possibility is a separate embodiment.

According to some embodiments, the vanilla bean may include at least at least 1%, at least 2%, at least 3% or at least 4% of 2-methyl-Butanal out of the total volatile fraction. Each possibility is a separate embodiment.

According to some embodiments, the vanilla is a vanilla bean metabolically modified by treatment with pyruvate.

According to some embodiments, the vanilla bean has a creamy vanilla flavor.

According to some embodiments, the vanilla bean may include at least 10%, at least 15%, at least 20% or at least 25% of 2,3-Butanediol out of the total volatile fraction. Each possibility is a separate embodiment.

According to some embodiments, the vanilla bean may include at least 2%, at least 3%, at least 4% or at least 5% 3-hydroxy-2-butanone, and/or at least 0.5%, at least 1%, or at least 2% 2,3-butanedione, and/or at least 0.5%, at least 1%, or at least 2% 2-methoxy p-cresol and/or at least 0.5%, at least 1%, or at least 2% 2,3-butanediol out of the total volatile fraction.

According to some embodiments, the vanilla bean may include an at least 10-fold or an at least 15-fold increase in the level of 3-hydroxy-2-butanone, as compared to other vanilla beans. According to some embodiments, the vanilla bean may include an at least 3-fold or an at least 5-fold increase in the level of % 2,3-butanedione and/or 2-methoxy p-cresol, as compared to other vanilla beans. According to some embodiments, the vanilla bean may include an at least 1.5-fold or an at least 2-fold increase in the level of 2,3-butanediol, as compared to other vanilla beans.

According to some embodiments, the vanilla is a vanilla bean metabolically modified by treatment with phenylalanine.

According to some embodiments, the vanilla bean has a non-vanillic flavor.

According to some embodiments, the vanilla bean may include at least 2.5%, at least 3%, at least 4% or at least 4.5% of Phenylethyl Alcohol out of the total volatile fraction. Each possibility is a separate embodiment.

According to some embodiments, the vanilla bean may include at least 2%, at least 3%, at least 4%, at least 5%, at least 6% or at least 7% of 3-Phenyl-2-propenoic acid methyl ester out of the total volatile fraction. Each possibility is a separate embodiment.

According to some embodiments, the vanilla bean may include Benzenecarbothioic acid, and/or 2-Hydroxy-1-phenyl-ethanone and/or Alpha-ethylidene-Benzeneacetaldehyde.

According to some embodiments, the vanilla bean may include at least 0.05%, at least 0.1%, at least 0.5% or at least 1% out of the total volatile fraction of any one or more of Benzenecarbothioic acid, 2-Hydroxy-1-phenyl-ethanone and/or Alpha-ethylidene-Benzeneacetaldehyde.

According to some embodiments, the vanilla is a vanilla bean metabolically modified by treatment with salicylic acid.

According to some embodiments, the vanilla bean has a vanillic nutty flavor.

According to some embodiments, the vanilla bean may include salicylic acid. According to some embodiments, the vanilla bean may include at least 0.05%, at least 0.1%, at least 0.5% or at least 1% salicylic acid out of the total volatile fraction.

According to some embodiments, the vanilla bean may include p-hydroxyphenyl Phosphonic acid. According to some embodiments, the vanilla bean may include at least 0.05%, at least 0.1%, at least 0.5% or at least 1% p-hydroxyphenyl Phosphonic acid.

According to some embodiments, the vanilla is a vanilla bean metabolically modified by treatment with a cocktail of elicitors.

According to some embodiments, the vanilla is a vanilla bean metabolically modified by treatment with valine, leucine and isoleucine.

According to some embodiments, the vanilla bean may include at least 0.5%, at least 1%, at least 2% or at least 3% 2-methyl-2-butenal, and/or at least 5%, at least 10% or at least 15% 2-methyl-butenal and/or at least 3%, at least 4% or at least 5% butenal and/or at least 0.5%, at least 1%, at least 2% acetic acid and/or at least 5%, at least 10% or at least 15% 3-methyl-butenal, and/or at least 0.5%, at least 1%, or at least 2% isophenyl alcohol and/or at least 0.25%, at least 0.5%, at least 1% or at least 1.5% 4-hydroxybutanoic acid lactone, out of the total volatile fraction.

According to some embodiments, the vanilla bean may include an at least 5-fold, an at least 10-fold or an at least 15-fold increase in the level of 2-methyl-2-butenal, as compared to other non-treated vanilla beans.

According to some embodiments, the vanilla is a vanilla bean metabolically modified by treatment with pyruvate and phenylalanine.

According to some embodiments, the vanilla bean may include at least 1%, at least 2% or at least 3% acetic acid out of the total volatile fraction. According to some embodiments, the vanilla bean may include an at least 2-fold, an at least 5-fold or an at least 10-fold increase in the level of acetic acid, as compared to other non-treated vanilla beans.

According to some embodiments, the vanilla bean may include at least at least 0.5%, at least 1% or at least 2% benzaldehyde, out of the total volatile fraction. According to some embodiments, the vanilla bean may include an at least 2-fold increase in the level of benzaldehyde, as compared to other non-treated vanilla beans. According to some embodiments, the vanilla bean may include an at least 2-fold increase or an at least 5-fold increase in the level of benzene acetaldehyde, and/or phenyl ethyl alcohol and/or isophenyl acetate, as compared to other non-treated vanilla beans.

According to some embodiments, the vanilla bean may include at least 7%, at least 8% or at least 10% dimethylene glycol, 2,3-butyleneglycol, out of the total volatile fraction.

According to some embodiments, the vanilla bean may include at least 2%, at least 2.5% or at least 3% vanillic acid, out of the total volatile fraction.

According to some embodiments, the vanilla bean may include at least 0.5%, at least 0.7% or at least 1% acetovanillone, out of the total volatile fraction.

According to some embodiments, the vanilla bean may include at least 0.5%, at least 0.7% or at least 1% vanillyl alcohol, out of the total volatile fraction.

According to some embodiments, the vanilla bean may include at least 10%, at least 12% or at least 15% hydroxydihydromaltol, out of the total volatile fraction.

According to some embodiments, the vanilla bean may include at least 0.5%, at least 0.7% or at least 1% Dehydrozingerone, out of the total volatile fraction.

According to some embodiments, the vanilla bean may include at least 0.5%, at least 0.7% or at least 1% vanillin-2,3-butylene glycol acetal, out of the total volatile fraction.

According to some embodiments, the vanilla bean may include at least 1.5%, at least 2% or at least 3% 2-Hydroxy-2,4-pentadienoate, out of the total volatile fraction.

According to some embodiments, the vanilla bean may include at least 0.5%, at least 0.7% or at least 1% iso butyl aldehyde, out of the total volatile fraction.

According to some embodiments, the vanilla bean may include at least 0.5%, at least 0.7% or at least 1% furaneol, strawberry furanone, out of the total volatile fraction.

According to some embodiments, the vanilla bean may include at least 10%, at least 12% or at least 15% guaiacol, out of the total volatile fraction.

According to some embodiments, the vanilla bean may include at least 0.5%, at least 0.7% or at least 1% phenyl alcohol, benzenol, out of the total volatile fraction.

According to some embodiments, the vanilla bean may include at least 1.5%, at least 2% or at least 3% 4-vinyl phenol, out of the total volatile fraction.

According to some embodiments, the vanilla bean may include at least 0.5%, at least 0.7% or at least 1% 4-cyclopentene-1,3-dione, out of the total volatile fraction.

According to some embodiments, the vanilla bean may include at least 0.5%, at least 0.7% or at least 1% cresol, out of the total volatile fraction.

According to some embodiments, the vanilla bean may include at least 0.5%, at least 0.7% or at least 1% vanillyl methyl ketone, out of the total volatile fraction.

According to some embodiments, the vanilla bean may include at least 20%, at least 25% or at least 30% 5-Hydroxymethylfurfural, out of the total volatile fraction.

According to some embodiments, the vanilla bean may include at least 2.5%, at least 3% or at least 3.5% palmitic acid, out of the total volatile fraction.

According to some embodiments, the vanilla bean may include at least 2%, at least 2.5% or at least 3% nonanaldehyde, out of the total volatile fraction.

According to some embodiments, the vanilla bean may include at least 2%, at least 2.5% or at least 3% lauric acid, out of the total volatile fraction.

According to some embodiments, the vanilla bean may include at least 2%, at least 2.5% or at least 3% capryl aldehyde, out of the total volatile fraction.

According to some embodiments, the vanilla bean may include at least 1%, at least 1.5% or at least 2% caproic acid, out of the total volatile fraction.

According to some embodiments, the vanilla bean may include at least 1%, at least 1.5% or at least 2% methyl palmitate, out of the total volatile fraction.

According to some embodiments, the vanilla bean may include at least 1%, at least 1.5% or at least 2% diacetyl, out of the total volatile fraction.

According to some embodiments, the vanilla bean may include at least 1%, at least 1.5% or at least 2% 2,4-decadienal, out of the total volatile fraction.

According to some embodiments, the vanilla bean may include at least 1%, at least 1.5% or at least 2% acetyl propionyl, out of the total volatile fraction.

According to some embodiments, the vanilla bean may include at least 1%, at least 1.5% or at least 2% ethyl palmitate, out of the total volatile fraction.

According to some embodiments, the vanilla bean may include at least 1%, at least 1.5% or at least 2% methyl linoleate, out of the total volatile fraction.

According to some embodiments, the vanilla bean may include at least 1%, at least 1.5% or at least 2% myristic acid, out of the total volatile fraction.

According to some embodiments, the vanilla bean may include at least 1%, at least 1.5% or at least 2% stearic acid, out of the total volatile fraction.

According to some embodiments, the vanilla bean may include at least 1%, at least 1.5% or at least 2% pentadecylic acid, out of the total volatile fraction.

According to some embodiments, the vanilla bean may include at least 4%, at least 5% or at least 6% hexanaldehdye, out of the total volatile fraction.

According to some embodiments, the vanilla bean may include at least 0.5%, at least 0.7% or at least 1% syringic aldehyde, out of the total volatile fraction.

According to some embodiments, the vanilla bean may include at least 6%, at least 8% or at least 10% 2-Amylfuran, out of the total volatile fraction.

According to some embodiments, the vanilla bean may include at least 4%, at least 5% or at least 6% ethyl acetate, out of the total volatile fraction.

According to some embodiments, the vanilla bean may include at least 2%, at least 2.5% or at least 3% Isovaleraldehyde, out of the total volatile fraction.

According to some embodiments, the vanilla bean may include at least 1%, at least 1.5% or at least 2% Methyl sec-butyl ketone, out of the total volatile fraction.

According to some embodiments, the vanilla bean may include at least 0.5%, at least 0.7% or at least 1% ethanal, out of the total volatile fraction.

According to some embodiments, the vanilla bean may include at least 0.5%, at least 0.7% or at least 1% p-hydroxybenzyl alcohol, out of the total volatile fraction.

According to some embodiments, the vanilla bean may include at least 1%, at least 1.5% or at least 2% squalene, out of the total volatile fraction.

According to some embodiments, the vanilla bean may include at least 1%, at least 1.5% or at least 2% phenylmethanol, out of the total volatile fraction.

According to some embodiments, the vanilla bean may include at least 1%, at least 1.5% or at least 2% hexahydrofarnesyl acetone, out of the total volatile fraction.

According to some embodiments, the vanilla bean may include at least 10%, at least 12% or at least 15% furfural, out of the total volatile fraction.

According to some embodiments, the vanilla bean may include at least 3%, at least 4% or at least 5% benzaldehyde, out of the total volatile fraction.

According to some embodiments, the vanilla bean may include at least 2.5%, at least 3% or at least 3.5% furfuryl alcohol, 2-furancarbinol, out of the total volatile fraction.

According to some embodiments, the vanilla bean may include at least 2%, at least 2.5% or at least 3% p-Vinylguaiacol, out of the total volatile fraction.

According to some embodiments, the vanilla bean may include at least 2%, at least 2.5% or at least 3% creosol, out of the total volatile fraction.

According to some embodiments, the vanilla bean may include at least 2%, at least 2.5% or at least 3% isopropyl methyl ketone, out of the total volatile fraction.

According to some embodiments, the vanilla bean may include at least 0.5%, at least 0.7% or at least 1% anisyl alcohol, out of the total volatile fraction.

According to some embodiments, the vanilla bean may include more vanillin than acetic acid.

According to some embodiments, the vanilla bean may include at least 2 times, at least 3 times, at least 4 times, at least 5 times, at least 10 times, at least 20 times, at least 30 times or at least 50 times more vanillin than acetic acid. Each possibility is a separate embodiment.

According to some embodiments, the vanilla bean may include more vanillin than creosol.

According to some embodiments, the vanilla bean may include at least 5 times, at least 10 times, at least 20 times at least 40 times or at least 60 times more vanillin than creosol. Each possibility is a separate embodiment.

According to some embodiments, the vanilla bean may include more acetic acid than creosol.

According to some embodiments, the vanilla bean may include at least 3 times, at least 4 times, at least 5 times, at least 6 times, or at least 8 times acetic acid than creosol. Each possibility is a separate embodiment.

According to some embodiments, the vanilla bean is characterized by presence of one or more metabolic markers.

As used herein the term “metabolic marker” refers to compounds not typically detected in untreated vanilla beans or being residually detected (below 0.01% or below 0.005% of the total volatile fraction) in untreated vanilla beans. Each possibility is a separate embodiment. The compounds are associated with the treatment, but do not necessarily influence the flavor of the treated beans. According to some embodiments, the metabolic marker refers to compounds which level rises to above 0.01%, above 0.5% or above 1% of the total volatile fraction as a result of the treatment. Each possibility is a separate embodiment.

According to some embodiments, the metabolic marker may be p-hydroxyphenyl Phosphonic acid, 4-isopropylphenyl carbonic acid methyl ester, Isosorbide, 2,4-di-tert-butylphenol, ethanol, ammonium acetate, isosorbide, 2,4-di-tert-butylphenol, 1-Methoxy-2-propyl acetate, Propyl-cyclopentane, 2-(2-Butoxyethoxy)-ethanol, Cyclobutanecarboxylic acid octyl ester and Octanoic acid ethyl ester, 2-Hydroxy-1-phenyl-ethanone, Benzenecarbothioic acid, 3-phenyl Furan, dimethyl Silanediol and Alpha-ethylidene-Benzeneacetaldehyde.or any combination thereof. Each possibility is a separate embodiment.

According to some embodiments, the vanilla bean is a vanilla bean metabolically modified by treatment with 2-Furoic acid. According to some embodiments, the 2-furoic acid treated vanilla bean may have an essentially pure vanilla taste (i.e. perceived as having more than 60% or more than 80% vanilla flavor out of the total flavors).

According to some embodiments, the vanilla bean is a vanilla bean metabolically modified by treatment with malic acid, maleic acid, succinic acid or serine. According to some embodiments, the malic acid, maleic acid, succinic acid or serine treated vanilla bean may have a distinct vanillic flavor (i.e. between 40%-60% vanilla flavor out of the total flavors).

According to some embodiments, the vanilla bean is a vanilla bean metabolically modified by treatment with fumaric acid or α-ketoglutaric acid. According to some embodiments, the fumaric acid or α-ketoglutaric treated vanilla bean may have a moderate vanillic flavor (between 20%-40% vanilla flavor out of the total flavors).

According to some embodiments, the vanilla bean is a vanilla bean metabolically modified by treatment with glycine, tyrosine, alanine or proline. According to some embodiments, the glycine, tyrosine, alanine or proline treated vanilla bean may have a little to no vanillic flavor (less than 10%, less than 5% or less than 1% vanilla flavor out of the total flavors).

According to some embodiments, the vanilla bean has increased levels of 3-hydroxy-Benzaldehyde and 2-methyl-Butanal providing a nutty coffee-like flavor and a decreased level of acetic acid, creosol and acetoin providing vinegar, anisic and floral flavors.

According to some embodiments, the vanilla bean may include at least 10%, at least 15% or at least 20% of 3-hydroxy-Benzaldehyde out of the total fraction of volatile compounds. Each possibility is a separate embodiment.

According to some embodiments, the vanilla bean may include at least at least 3%, at least 4% at least 5%, at least 6% or at least 7% of 3-phenyl-2-Propenoic acid methyl ester out of the total fraction of volatile compounds. Each possibility is a separate embodiment.

According to some embodiments, the vanilla bean may include at least 1%, at least 2%, at least 3% or at least 4% of 2-methyl-Butanal out of the total volatile fraction. Each possibility is a separate embodiment.

According to some embodiments, the vanilla is a vanilla bean metabolically modified by treatment with pyruvate.

According to some embodiments, the vanilla bean has a creamy vanilla flavor.

According to some embodiments, the vanilla bean may include at least 10%, at least 15%, at least 20% or at least 25% of 2,3-Butanediol out of the total volatile fraction. Each possibility is a separate embodiment.

According to some embodiments, the vanilla bean may include at least 2%, at least 3%, at least 4% or at least 5% 3-hydroxy-2-butanone, and/or at least 0.5%, at least 1%, or at least 2% 2,3-butanedione, and/or at least 0.5%, at least 1%, or at least 2% 2-methoxy p-cresol and/or at least 0.5%, at least 1%, or at least 2% 2,3-butanediol out of the total volatile fraction.

According to some embodiments, the vanilla bean may include an at least 10-fold or an at least 15-fold increase in the level of 3-hydroxy-2-butanone, as compared to other vanilla beans. According to some embodiments, the vanilla bean may include an at least 3-fold or an at least 5-fold increase in the level of % 2,3-butanedione and/or2-methoxy p-cresol, as compared to other vanilla beans. According to some embodiments, the vanilla bean may include an at least 1.5-fold or an at least 2-fold increase in the level of 2,3-butanediol, as compared to other vanilla beans.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

### Example 1—Vanillin Levels in Treated Beans

Target chemical compounds (set forth in table 1 below) were dissolved in water and pH adjusted to pH-7. Green beans cut into 1 cm pieces were placed in a 50 ml tube or intact beans placed in a bucket. A 10 ml solution containing one of the compounds indicated in Table 1 dissolved in water and 0.1% of each of the four surfactants tween 20, tween 80, span 20, and span 80 was added per each bean.

TABLE 1
Tested chemical compounds.

| Compound | Family | Concentration | |
|---|---|---|---|
| Control water | No | No | |
| p-Coumaric acid | Pathway intermediate | 1 | mM |
| trans-Cinnamic acid | Pathway intermediate | 1 | mM |
| Ferulic acid | Pathway intermediate | 25 | mM |
| L-Phenylalanine | Pathway intermediate | 100 | mM |
| Alanine | General metabolites | 100 | mM |
| Proline | General metabolites | 100 | mM |
| Pyruvic acid | General metabolites | 100 | mM |
| Glucose | General metabolites | 100 | mM |
| Fructose | General metabolites | 100 | mM |
| Sucrose | General metabolites | 100 | mM |
| L- glutathione | General metabolites | 100 | mM |
| Methyl jasmonate | Elicitor | 10 | mM |
| Salicylic acid | Elicitor | 25 | mM |
| Chitosan | Elicitor | 1 | mM |
| Cyclodextrin | Elicitor | 25 | mM |
| Xylose | Elicitor | 25 | mM |
| Pectin | Elicitor | 50 | mM |
| Kinetin | Elicitor | 25 | mM |
| Dextran | Elicitor | 10 | mM |
| Indole butyric acid | Hormone | 1 | mM |

The beans were incubated with the solution for 0.5-36 hours (e.g. overnight) at room temperature. The solution was the filtered out, the beans washed, and placed in a drying chamber with controlled temperature and humidity conditions to provide killing and curing as known in the art. The beans were weighted daily and at a 25-30% of their original weight, subjected to vanillin content analysis by spectrophotometry, as well as to a flavor test by a sensory panel.

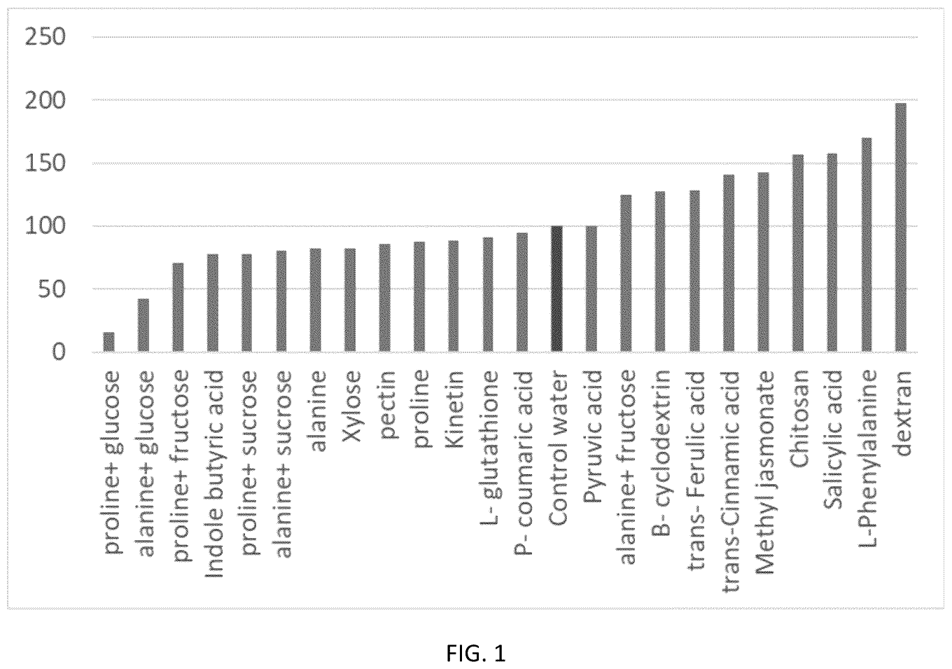

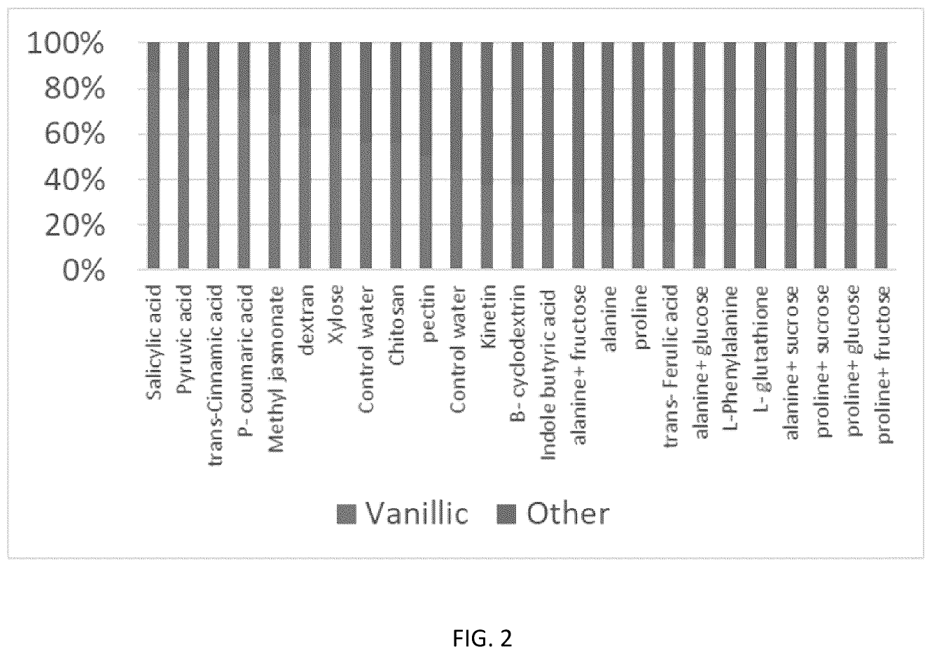

As seen from FIG. 1, different compounds caused an increase in different flavor compounds providing a unique flavor profile for each compound. Interestingly, as seen from the sensory panel evaluation (FIG. 2), the change in flavor compounds resulted in a corresponding flavor sensation. For example, beans treated with salicylic acid (causing a large increase in the abundance of vanillin), were perceived as having a strong vanillic flavor, while beans treated with phenylalanine, glutathione or sugars (having reduced vanillin content) were perceived as having a non-vanillic flavor. Both experiments were repeated three times with similar results.

### Example 2—Vanilla Bean Flavor Profile Alteration

The treated vanilla beans were further analyzed by Gas Chromatography-Mass Spectrometry (GC-MS) in headspace mode with solid phase micro extraction (SPME) fiber. Compound identification was done by retention index and mass spectra. Compound flavor was obtained by searching a compound name in the following databases: https://pubchem.ncbi.nlm.nih.gov/ and http://www.thegoodscentscompany.com/.

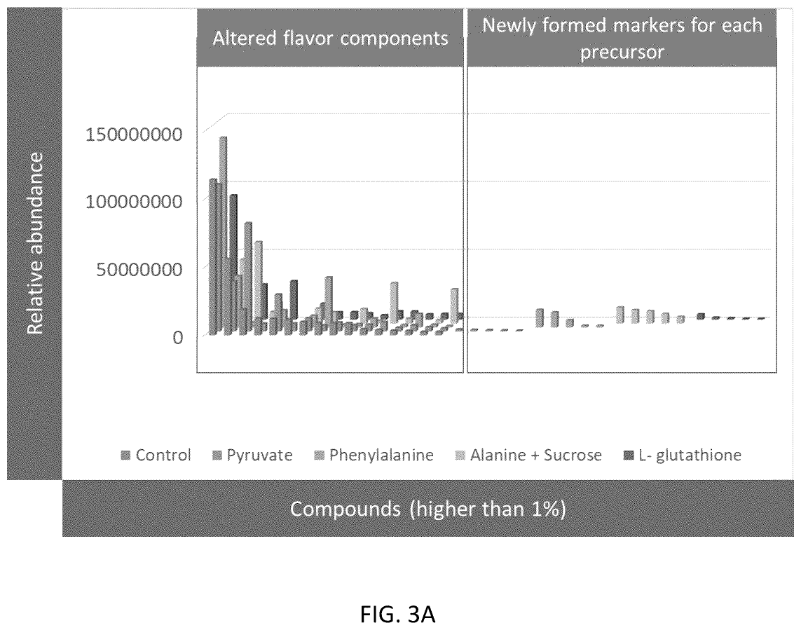

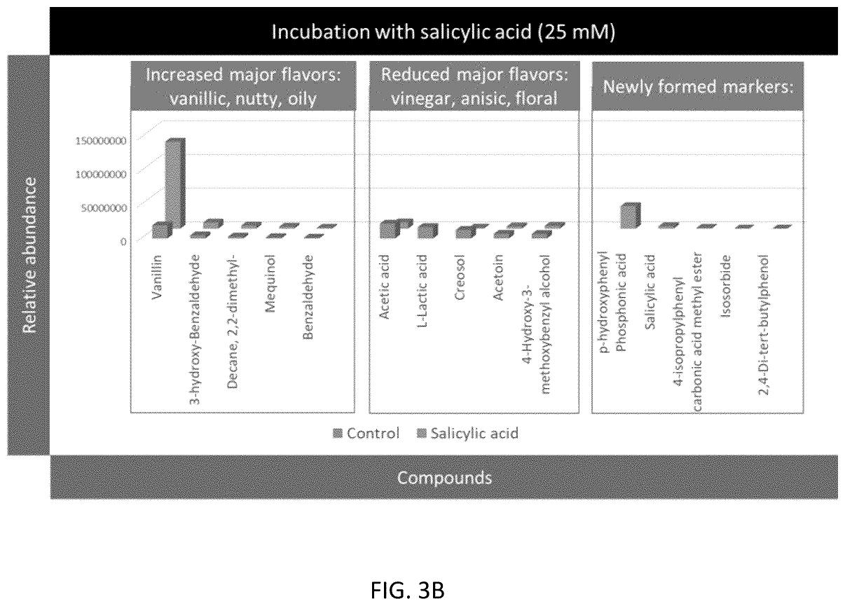

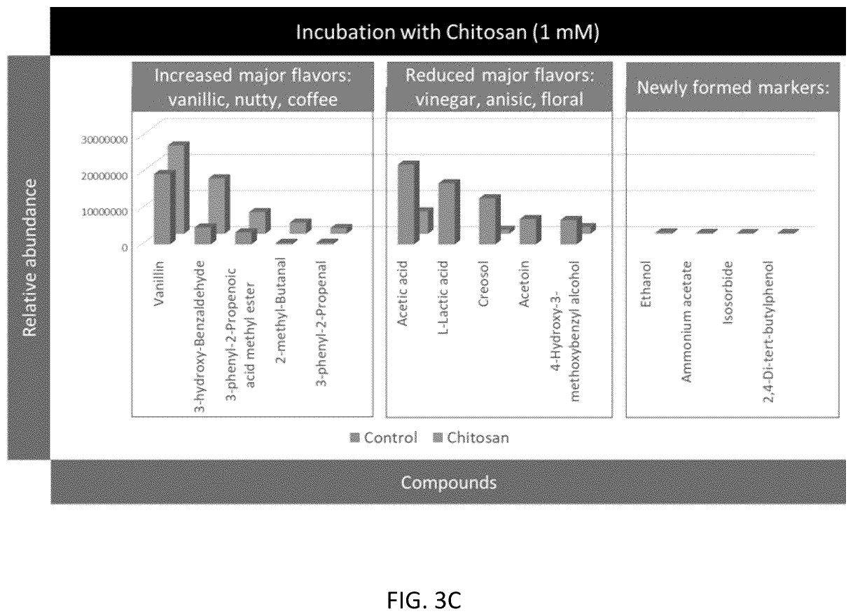

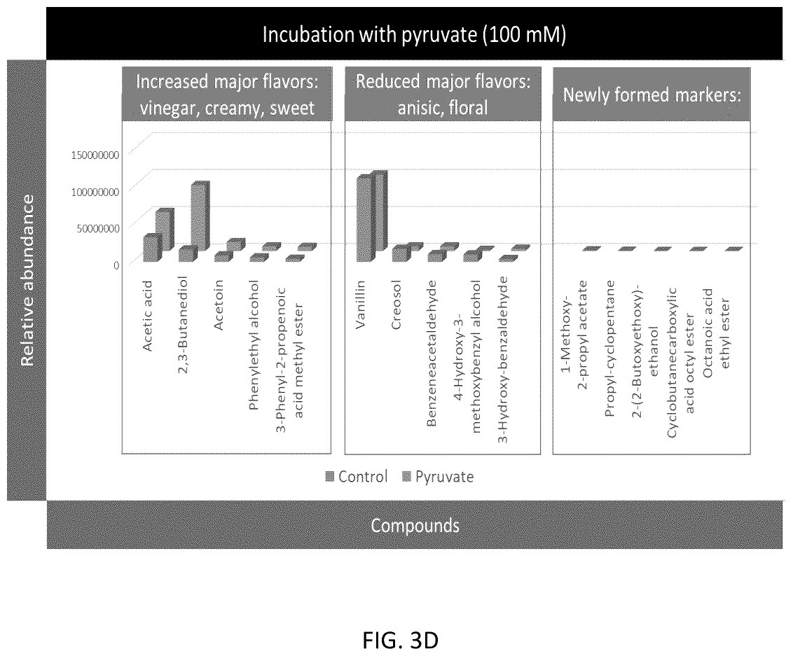

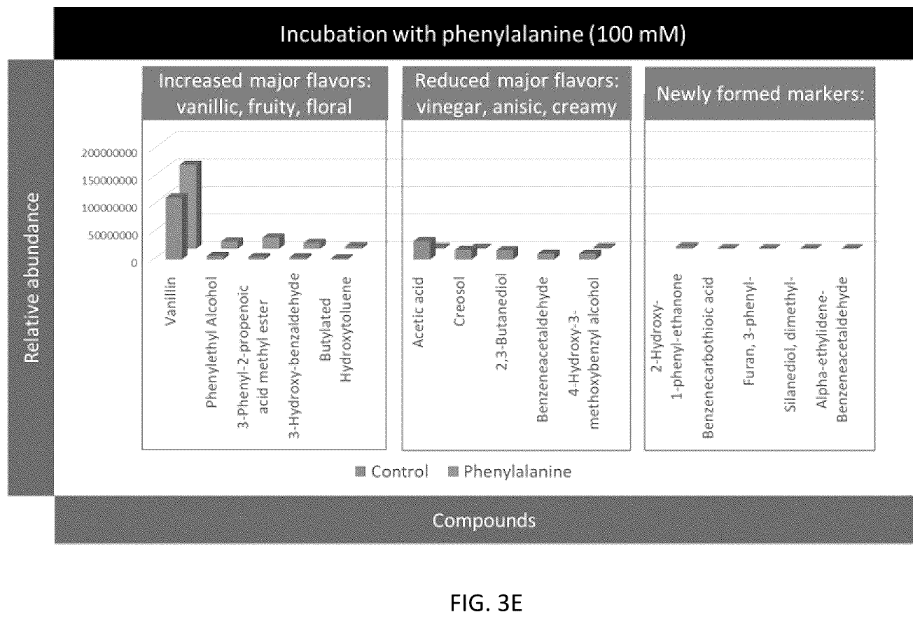

As seen from FIG. 3A-FIG. 3E, the GC-MS analysis confirmed both effects, an increase in vanillin levels and flavor profile alteration, when treating beans with phenylalanine, Pyruvate, Alanine+sucrose and L-glutathione. Each of the compounds used to enhance flavors resulted in a different flavor profile proving the ability of the herein disclosed method to alter the flavor profile of vanilla beans. The analysis was repeated twice with similar results.

As seen from FIG. 3B, salicylic acid, identified by the flavor panel as inducing a strong vanilla taste, indeed caused a marked increase in vanillin levels, while chitosan treatment, identified by the panel as resulting in beans with a milder increase in vanilla flavor, exhibited a milder increase in vanillin levels (FIG. 3C).

Salicylic acid feeding further increased the levels of constituents resulting in a nutty flavor (3-hydroxy-Benzaldehyde) with a decrease in major constituents delivering vinegar anisic and floral flavors such as acetic acid, creosol and Acetoin (FIG. 3B). Metabolic markers such as p-hydroxyphenyl Phosphonic acid, 4-isopropylphenyl carbonic acid methyl ester, Isosorbide, 2,4-di-tert-butylphenol as well as salicylic acid were also identified (FIG. 3B).

Chitosan feeding, on the other hand further increased the levels of constituents delivering a nutty coffee flavor (3-hydroxy-Benzaldehyde and 2-methyl-Butanal) with a decrease in constituents delivering vinegar anisic and floral flavors, such as acetic acid, creosol and acetoin (FIG. 3C). Notably, low levels of metabolic markers were also formed, namely ethanol, ammonium acetate, isosorbide, 2,4-di-tert-butylphenol (FIG. 3C).

Other compounds, such as pyruvate induced a change in the flavor profile, by resulting in the formation compounds giving the beans a vinegar, creamy and sweet flavor, such as acetic acid and 2, 3-Butanediol and acetoin (FIG. 3D), while decreasing the level of compounds giving a anisic and floral flavors (creosol and benzeneacetaldehyde). The metabolic markers associated with pyruvate treatment were 1-Methoxy-2-propyl acetate, Propyl-cyclopentane, 2-(2-Butoxyethoxy)-ethanol, Cyclobutanecarboxylic acid octyl ester and Octanoic acid ethyl ester.

Phenylalanine (FIG. 3E) and glutathione (results not shown) induced the formation of compounds Phenylethyl Alcohol and 3-Phenyl-2-propenoic acid methyl ester (in addition to an increase in vanillin) giving the beans a floral fruity flavor and reduced abundance of compounds giving the beans a vinegar anisic and creamy flavor (acetic acid, creosol and 2,3-Butanediol). The metabolic markers associated with phenylalanine treatments were 2-Hydroxy-1-phenyl-ethanone, Benzenecarbothioic acid, 3-phenyl Furan, dimethyl Silanediol and Alpha-ethylidene-Benzeneacetaldehyde.

Interestingly, along with the increase or decrease of major flavor constituents (forming a unique pattern) the treatment with the compounds also resulted in the formation of low levels of unique flavor markers, not found in regular vanilla beans (FIG. 3A-FIG. 3E), such as, for example, p-hydroxyphenyl Phosphonic acid.

Table 2 below summarizes some flavor/aroma modification achieved by the treatments.

TABLE 2
Flavor effects following chemical compound treatment.

| Compound | Family | Flavor effect |
|---|---|---|
| L-Phenylalanine | Pathway intermediate | Vanillic, fruity |
| Leucine | General metabolites | Nutty, chocolate |
| Isoleucine | General metabolites | Nutty, chocolate |
| Valine | General metabolites | Nutty, chocolate |
| Pyruvic acid | General metabolites | Vinegar, creamy, sweet |
| Salicylic acid | Elicitor | Vanillic, nutty |
| Chitosan | Elicitor | Vanillic, nutty, coffee |
| L- glutathione | General metabolites | Fruity |

### Example 3—Metabolic Manipulation Using Elicitor Cocktails

a) Valine, leucine and isoleucine (25 mM) were dissolved in water and pH adjusted to pH=7. Whole green vanilla beans (killed by freezing-thawing) were placed in a bucket. A 10 ml solution containing the valine, leucine and isoleucine cocktail and 0.1% of each of tween 20, tween 80, span 20, and span 80 was added to the beans.

The treated vanilla beans were analyzed by Gas Chromatography-Mass Spectrometry (GC-MS) in headspace mode with solid phase micro extraction (SPME) fiber, as described above.

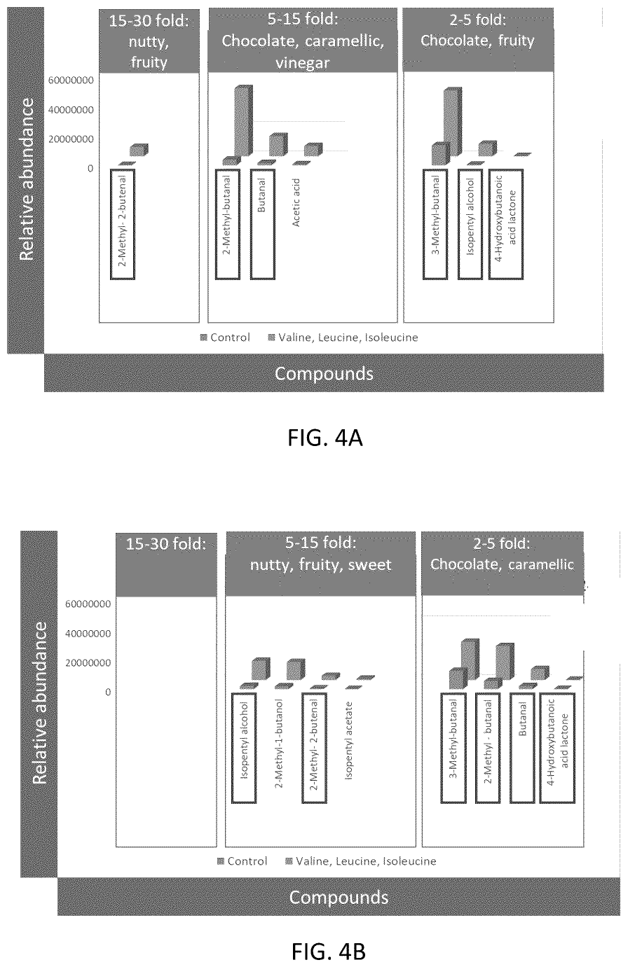

As seen from FIG. 4A, the treatment resulted in a 15-30 fold increase in 2-methyl-2butenal (providing a nutty flavor to the beans) and a 5-15 fold increase in the levels of 2-methyl-butanal, butanal and acidic acid (providing a chocolate, caramel and vinegar flavor to the beans), as compared to control. In addition, a 2-5-fold increase was also obtained for 3-methyl-butanal, isophenyl alcohol and 4-hydroxybutanoic acid lactone (providing a chocolate, fruity flavor to the beans), as compared to control (untreated). The analysis was repeated twice with similar results.

Interestingly, when killing by freezing-thawing was substituted with mechanical killing, an even larger increase in the level of isophenyl alcohol was obtained, while the increase in 2-methyl-2 butenal was less significant (see FIG. 4B).

b) pyruvate and phenylalanine (100 mM and 25 mM) were dissolved in water and pH adjusted to pH=7. Whole green vanilla beans killed by freezing thawing were placed in a bucket. A 10 ml solution containing the pyruvate and phenylalanine cocktail and 0.1% of each of tween 20, tween 80, span 20, and span 80 was added to the beans, untreated beans were used as a control.

The treated vanilla beans were analyzed by Gas Chromatography-Mass Spectrometry (GC-MS) in headspace mode with solid phase micro extraction (SPME) fiber, as described above.

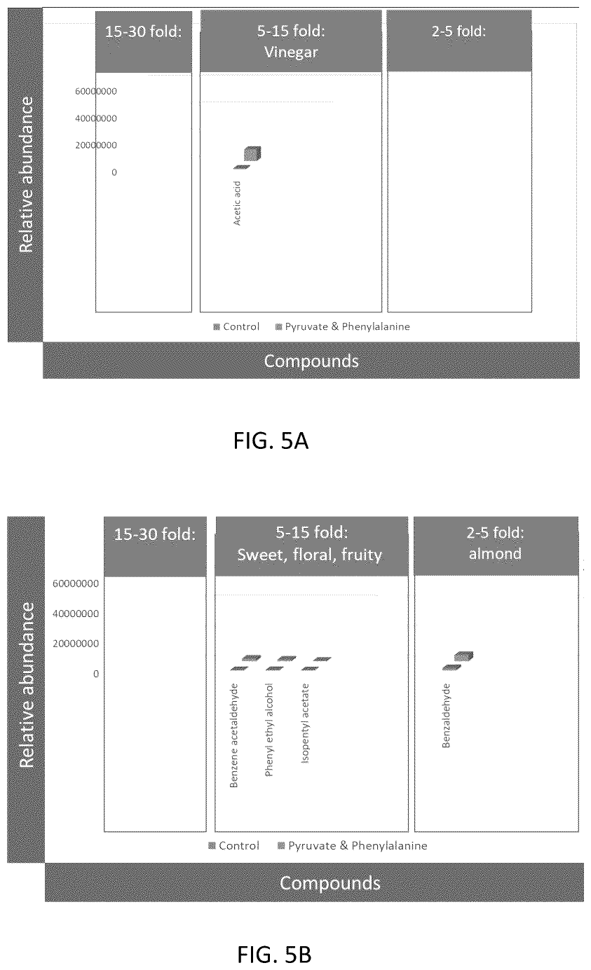

As seen from FIG. 5A, the treatment resulted in a 5-15 fold increase in the levels of acetic acid (providing vinegar flavor to the beans), as compared to control (killing by freezing and thawing). The analysis was repeated twice with similar results.

Surprisingly, when killing freezing-thawing was substituted with mechanical killing, the increase in acetic acid levels was substituted with increased levels of benzene acetaldehyde, phenyl ethyl alcohol and isophenyl acetate (providing a sweet, floral and fruity flavor to the beans) and in benzaldehyde (providing beans with almond flavor) (see FIG. 5B), as compared to control (no elicitor).

### Example 4—Metabolic Manipulation by Mechanical Killing

Whole green vanilla beans were subjected to mechanical disruption and analyzed by Gas Chromatography-Mass Spectrometry (GC-MS) in headspace mode with solid phase micro extraction (SPME) fiber, as described above.

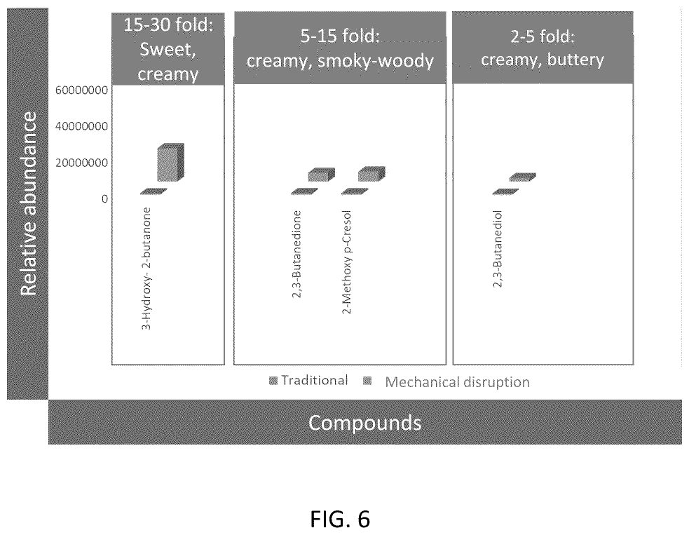

Surprisingly, subjecting the vanilla beans to mechanical killing in itself resulted in an altered metabolic profile as compared to beans which were killed by heating. Inter alia, as seen from FIG. 6, a vast increase (24-fold) in 3-hydroxy-2-butanone (providing a sweet and creamy flavor to the beans) as well large increases in 2,3-butanedione and 2-3-methoxy p-cresol (providing a creamy and smoky-woody flavor to the beans).

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

### Example 5—Vanillin Levels in Treated Beans

Target chemical compounds (set forth in table 3 below) were dissolved in water and pH adjusted to pH=7. Green beans were placed in a bucket and covered with the solution comprising a compound according to the listed in Table 3 and a surfactant.

TABLE 3
Tested chemical compounds.

| Treatment number | Compound |
|---|---|
| 1 | α-Ketoglutaric acid |
| 2 | Malic acid |
| 3 | Fumaric acid |
| 4 | Succinic acid |
| 5 | Maleic acid |
| 6 | Glycine |
| 7 | Serine |
| 8 | Tyrosine |
| 9 | 2-Furoic acid |
| 10 | Alanine |
| 11 | Proline |
| 12 | Hydroxy proline |
| 13 | Histidine |

The beans were incubated with the solution for 0.5-36 hours at room temperature. The solution was then filtered out and placed in a drying chamber with controlled temperature and humidity conditions to provide killing and curing as known in the art. The beans were weighted daily and at a 25-30% of their original weight, subjected to vanillin content analysis by spectrophotometry, as well as to a flavor test by a sensory panel.

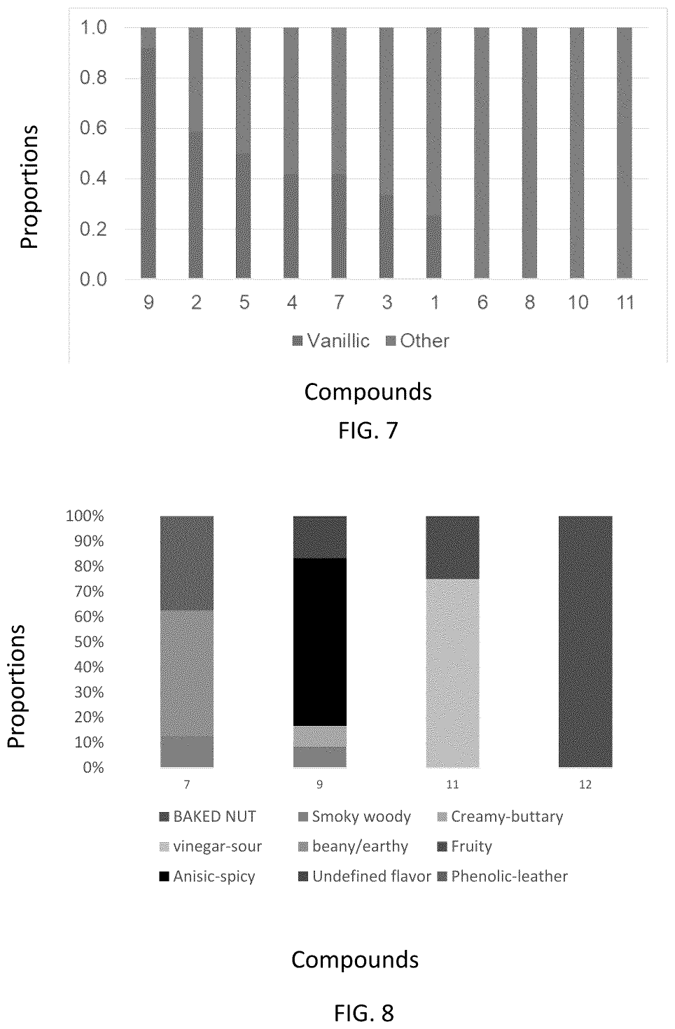

As seen from FIG. 7, different compounds caused an increase in different flavor compounds providing a unique flavor profile for each compound. For example, beans treated with 2-Fuoric acid (treatment 9), were perceived as having a strong vanillic flavor, while beans treated with amino acids (treatments 6, 8, 10 and 11) were perceived as having a non-vanillic flavor. Interestingly, as seen from FIG. 8, each amino acid caused its own, at times non-vanillic taste profile. Proline resulted in a strong flavor of baked nuts, while alanine resulted in a mostly vinegar-sour and fruity flavor.

1-41. (canceled)

42. A method for manipulating a metabolic profile of whole vanilla beans, the method comprising adding a chemical compound to a solution comprising the vanilla beans, such that the chemical compound penetrates into the vanilla beans, thereby obtaining vanilla beans having a modified metabolic profile, wherein manipulating the metabolic profile comprises enhancing a flavor of the vanilla bean, modifying a flavor profile of the vanilla bean, changing a color of the vanilla bean or any combination thereof, and wherein the method is carried out after harvest of the vanilla bean.

43. The method of claim 42, wherein the chemical compound is a flavor compound intermediate, an elicitor, a hormone, a metabolite or any combination thereof.

44. The method of claim 43, wherein the chemical compound is selected from the group of p-Coumaric acid, trans-Cinnamic acid, Ferulic acid, Leucine, Isoleucine, L-Phenylalanine, Valine Alanine, Proline, Pyruvic acid, Glucose, Fructose, Sucrose, L-glutathione, Methyl jasmonate, Salicylic acid, Chitosan, Cyclodextrin, Xylose, Pectin, Kinetin, Dextran, Indole butyric acid, α-ketoglutaric acid, malic acid, fumaric acid, succinic acid, maleic acid, glycine, serine, 2-furoic acid, alanine, hydroxyproline, histidine or any combination thereof.

45. The method of claim 44, wherein the chemical compound is selected from L-Phenylalanine, Leucine, Isoleucine, Valine, Pyruvic acid, Salicylic acid, Chitosan, L-glutathione or any combination thereof.

46. The method of claim 42, wherein adding the chemical compound comprises adding 0.1-500 mM of the metabolic manipulation compound.

47. The method of claim 42, further comprising adding a penetration agent to the solution.

48. The method of claim 47, wherein the penetration agent is a non-ionic surfactant.

49. The method of claim 48, wherein the surfactant is selected from the group of PEG 20 sorbitan monolaurate, PEG 20 sorbitan monooleate, Sorbitan monolaurate, Sorbitan monooleate, or any combination thereof.

50. The method of claim 47, wherein adding the penetration agent comprises adding 0.1%-5% of the penetration agent.

51. The method of claim 42, wherein the vanilla beans are incubated with the chemical compound for at least 24 h.

52. The method of claim 42, further comprising subjecting the vanilla beans to killing by mechanical disruption prior to the treating of the vanilla beans with the chemical compound.

53. A vanilla bean obtained according to the method of claim 42.

54. The vanilla bean of claim 53, comprising at least 10% 3-hydroxy-Benzaldehyde out of total volatile fraction.

55. The vanilla bean of claim 53, comprising at least 3% 3-phenyl-2-Propenoic acid methyl ester out of total volatile fraction.

56. The vanilla bean of claim 53, comprising at least 1% 2-methyl-Butanal.

57. The vanilla bean of claim 53, comprising less than 10% acetic acid, creosol and/or acetoin.

58. The vanilla bean of claim 57, further comprising ethanol, ammonium acetate, isosorbide and/or 2,4-di-tert-butylphenol.

59. The vanilla bean of claim 53, comprising at least 0.05% Salicylic acid and/or p-hydroxyphenyl Phosphonic acid.

60. The vanilla bean of claim 59, further comprising 4-isopropylphenyl carbonic acid methyl ester, Isosorbide, and/or 2,4-di-tert-butylphenol.

61. The vanilla bean of claim 53, comprising at least 10% 2,3-Butanediol out of total volatile fraction.
